(19) United States
(12) Patent Application Publication
(10) Pub. No.: US 2004/0222951 A1
(43) Pub. Date: Nov. 11, 2004

(54) Organic electroluminescent panel with reduced power consumption and method for making the same

(75) Inventors: Jiun-Haw Lee, Taipei City (TW); Shin-Chi Chien, Dasi Township (TW); Peir-Jy Hu, Hukou Township (TW)

Correspondence Address: BACON & THOMAS, PLLC, 625 SLATERS LANE, FOURTH FLOOR, ALEXANDRIA, VA, 22314

(73) Assignee: RiTdisplay Corporation, Hukou Township (TW)

(21) Appl. No.: 10/738,041

(22) Filed: Dec. 18, 2003

(30) Foreign Application Priority Data
Dec. 18, 2002 (TW) 091136567

(51) Int. Cl. G09G 3/30

(52) U.S. Cl. 345/77

(57) ABSTRACT

An organic electroluminescent panel having reduced power consumption and a method for reducing the power consumption thereof is disclosed, which uses a micro-processer for outputting an electrical signal for power-saving instruction to a controller, and thereby adjusts the scanning scope or area, the refreshing frequency, or the displaying clock of the power-saving display frame, or the displaying luminance of the standby screen of the power-saving display frame, selectively. Afterwards, the stored scanning scope or area, the stored refreshing frequency, or the stored displaying clock of the power-saving display frame, or the stored displaying luminance of the standby screen of the power-saving display frame are transmitted to a driver for driving the organic electroluminescent panel.

### BACKGROUND OF THE INVENTION

1. Field of the Invention

The present invention relates to a method for reducing the power consumption of an organic electroluminescent panel and, more particularly, to an organic electroluminescent panel having reduced power consumption and a method for reducing the power consumption thereof.

2. Description of Related Art

Since the introduction of modern computing, the display has become the most important interface between the user and the computer. Since the beginning of the 1990's, technological developments combined with market demands have resulted in constant upgrading of displays available to consumers. More recently, the flat panel display (FPD) has gradually replaced the traditional cathode ray tube (CRT) display and become the mainstream in the display marketplace owing to its low weight, compact size and attractive styling. Among the flat panel displays, the organic electroluminescent panel is a particularly favored new generation display due to its advantages of lightweight, high contrast, fast response time, low power consumption, and high luminance, etc.

The organic electroluminescent panel is a device that utilizes the organic functional materials, which radiate spontaneously to achieve image display. According to the molecular weight of the organic functional materials, the organic electroluminescent panel is classified into two types, i.e. the small molecule OLED (SM-OLED) and the polymer light-emitting device (PLED).

The display of the images on the organic electroluminescent panel is achieved by driving pixels arranged in a matrix on the OLED. As shown in FIG. 1, the pixels of the OLED on the intersecting-spot of the stripes of the column electrodes and the stripes of the row electrodes is addressed and driven by the lateral lead-out lines which electrically connect the stripes of the column electrodes and the stripes of the row electrodes in the active area of the OLED at the peripheral of the OLED. In other words, the ends of the stripes of the column electrodes or that of the row electrodes are drawn out for electrically inputting signals to the OLED. For example, the endpoints of the columns can be used to input the data signals for displaying, and the endpoints of the rows can be used to input the scanning signals for displaying. Generally, the time for scanning a cycle of scanning signals of all pixels from the top row to the bottom row is called a frame period.

In addition, the organic electroluminescent media of the organic electroluminescent panel are moisture or oxygen sensitive, which is easily deteriorated due to the frequent switching or speedy switching of high driving currents The organic electroluminescent media of the organic electroluminescent panel are also easily degraded due to the heat accompanied with the illuminating of the pixel, and thereby shortens the lifetime of the organic electroluminescent panel. Therefore, preventing the same pixels from frequently repeated illumination becomes important for substantially extending the lifetime of all the pixels in the active area.

However, many commercial products, such as the liquid crystal display, often turns on most or all pixels in the active area for only displaying a small areas of few rows or columns of pixels, and thus consumes a lot of electric power. In most cases, most of the information, images are displayed in some areas by the designing custom of the programmer. Therefore, most of the active areas are substantially separated into areas for frequent displaying and areas without frequent displaying. Just as shown in FIG. 2, the areas 11, 12, and 13 are the areas for frequent displaying which are always lightened on, and the area 14 is the always-dark area. However, even though that the illuminance is low, currents are still required for maintaining low illuminance on the OLED. As a result, high percentage of power consumption of the display panel is wasted on the dark area 14.

Therefore, it is desirable to provide an organic electroluminescent panel having reduced power consumption and method for reducing the power consumption thereof to mitigate and/or obviate the aforementioned problems.

### SUMMARY OF THE INVENTION

The present invention is to provide a method for reducing the power consumption of an organic electroluminescent panel so that the power consumption of the organic electroluminescent panel is reduced, the energy-saving efficiency of the power is raised, and the lifetime of the organic electroluminescent panel is extended.

The present invention is also to provide an organic electroluminescent panel having reduced power consumption so that the power consumption of the organic electroluminescent panel is reduced, the energy-saving efficiency of the power is raised, and the lifetime of the organic electroluminescent panel is extended.

The present invention is also to provide a circuit of organic electroluminescent panel for reducing power consumption so that the power consumption of the organic electroluminescent panel is reduced, the energy-saving efficiency of the power is raised, and the lifetime of the organic electroluminescent panel is extended. The method for reducing the power consumption of an organic electroluminescent panel of the present invention comprises the following steps: (A) providing an organic electroluminescent panel, a controller and drivers for driving the organic electroluminescent panel; wherein the controller connects, controls the drivers to drive the organic electroluminescent panel, receives an electrical signal for power-saving instruction by the controller, and adjusts the scanning scope or the scanning area of a power-saving display frame on the organic electroluminescent panel; (B) reducing the refreshing frequency of the power-saving display frame, the displaying clock of the power-saving display frame, or the displaying luminance of a standby screen of the power-saving display frame of the organic electroluminescent panel by the controller; (C) storing the scanning scope or area of the power-saving display frame, the refreshing frequency of the power-saving display frame, the displaying clock of the power-saving display frame, or the displaying luminance of the standby screen of the power-saving display frame in a memory, and transmitting the stored scanning scope of the power-saving display frame, the stored refreshing frequency of the power-saving display frame, the stored displaying clock of the power-saving display frame, or the stored displaying luminance of the standby screen of the power-saving display frame to the drivers of the organic electroluminescent panel; and (D) driving the organic electroluminescent panel to display the power-saving display frame or the standby screen of the power-saving display frame by the drivers.

The organic electroluminescent panel having reduced power consumption of the present invention comprises a controller for receiving an electrical signal for power-saving instruction, adjusting and sending out at least one parameter; a memory for storing the parameter adjusted in the controller; at least one driver for receiving the parameter from the controller and sending out a control signal; and an organic electroluminescent panel for receiving the control signal from the driver for displaying.

The circuit of organic electroluminescent panel for reducing power consumption comprises a controller for receiving an electrical signal for power-saving instruction, adjusting and sending out at least one parameter, and a memory for storing the parameter adjusted in the controller.

The scanning scope or the scanning area of the power-saving display frame of the method for reducing the power consumption of an organic electroluminescent panel of the present invention is not restricted. Preferably, the scanning scope or the scanning area of the power-saving display frame of the present invention is adjusted to be equal to or greater than the area or the scope of the display block having the highest pixel-on frequency or display frequency in step (A). The displaying luminance of the standby screen of the power-saving display frame of the present invention can be adjusted by any conventional methods. Preferably, the displaying luminance is achieved by reducing the driving current for driving pixels of the organic electroluminescent panel. The refreshing frequency, the displaying clock, or the displaying luminance of the standby screen of the display frame of the present invention can be adjusted by any conventional methods. Preferably, the refreshing frequency, the displaying clock, or the displaying luminance of the standby screen of the display frame of the present invention is reduced by a controller. Preferably, the method for reducing the power consumption of an organic electroluminescent panel of the present invention further comprises setting the period for displaying the pixel array or various display frames in step (B) in order to display the pixel of the organic electroluminescent panel averagely. The scanning scope of the power-saving display frame, the refreshing frequency of the power-saving display frame, the displaying clock of the power-saving display frame, or the displaying luminance of the standby screen of the power-saving display frame of the present invention can be stored at any conventional memory device. Preferably, the scanning scope of the power-saving display frame, the refreshing frequency of the power-saving display frame, the displaying clock of the power-saving display frame, or the displaying luminance of the standby screen of the power-saving display frame is stored at a register. The drivers of the organic electroluminescent panel having reduced power consumption of the present invention can be any conventional drivers. Preferably, the driver is a data driver that receives data-signals to drive the organic electroluminescent panel, or a scan driver that receives scanning signals to drive the organic electroluminescent panel.

Further, the time period or the switching frequency for displaying the pixel array or various display frames can be set to display the pixel of the organic electroluminescent panel averagely (as shown in FIG. 5) so that the overusing of the same pixels that may lead to the ineffectiveness of those pixels is prevented, the displaying quality is improved, and the lifetime of the display panel is therefore extended.

Otheradvantages and novel features of the invention will become more apparent from the following detailed description when taken in conjunction with the accompanying drawings.

### BRIEF DESCRIPTION OF THE DRAWINGS

FIG. 1 is a schematic view showing the matrix of prior organic electroluminescent panel;

FIG. 2 is a schematic view showing the display area of the electrical products of the prior arts;

FIG. 3 is a block diagram of the organic electroluminescent panel having reduced power consumption of the present invention;

FIG. 4 is a flow chart showing the method for reducing the power consumption of an organic electroluminescent panel of the present invention; and

FIG. 5 is a schematic view showing the power-saving mode of the present invention.

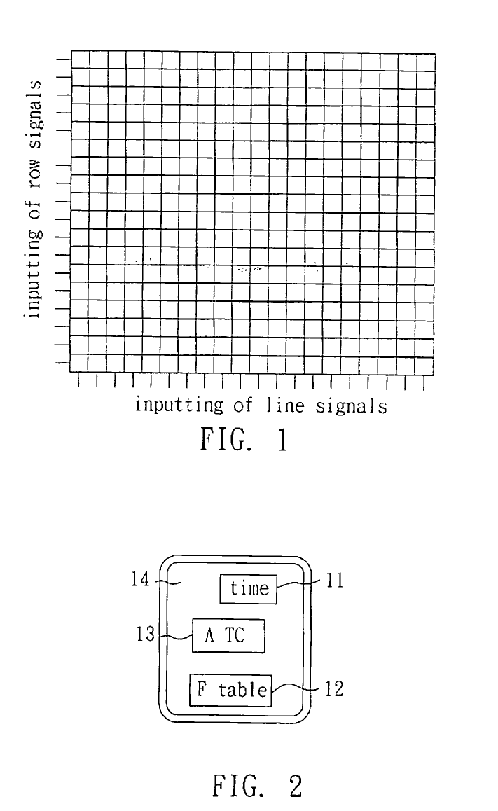

### DETAILED DESCRIPTION OF THE PREFERRED EMBODIMENT

The theory used in the method for reducing the power consumption of an organic electroluminescent panel of the present invention will be described in the following. Because the power consumed by the electronic devices is mostly calculated according to the formula (1) below:

P=cV² ƒ (1)

wherein c is the capacitance, V is the voltage, and f is the scanning frequency. Therefore, if the scanning frequency is reduced, then the capacitive power consumption of the organic electroluminescent panel will be lowered. The present invention lowers the capacitive power consumption of the panel by reducing the scanning frequency, and thereby reduces the power consumption of the display panel vastly. Similarly, if the number of the scanning row is reduced, then the peak current required can also be reduced, and thereby the power consumption can be saved, as illustrated by the formula (2) below:

(Peak luminance)=(Average luminance)×(No. of row) (2)

On the other hand, if the organic electroluminescent operates at low luminance, then the energy-saving efficiency of power will be increased, and the lifetime of the organic panel will be extended.

Furthermore, the reduction in peak current also decreases the resistance power consumption produced by the cathode and anode conductive lines, as shown in the formula (3) below:

P=I²R (3)

Therefore, if the driving method of the organic electroluminescent panel is improved to reduce the scanning frequency without influencing the displaying of the organic electroluminescent panel, then the power consumption of the organic electroluminescent panel will be reduced, and the lifetime thereof will be extended simultaneously.

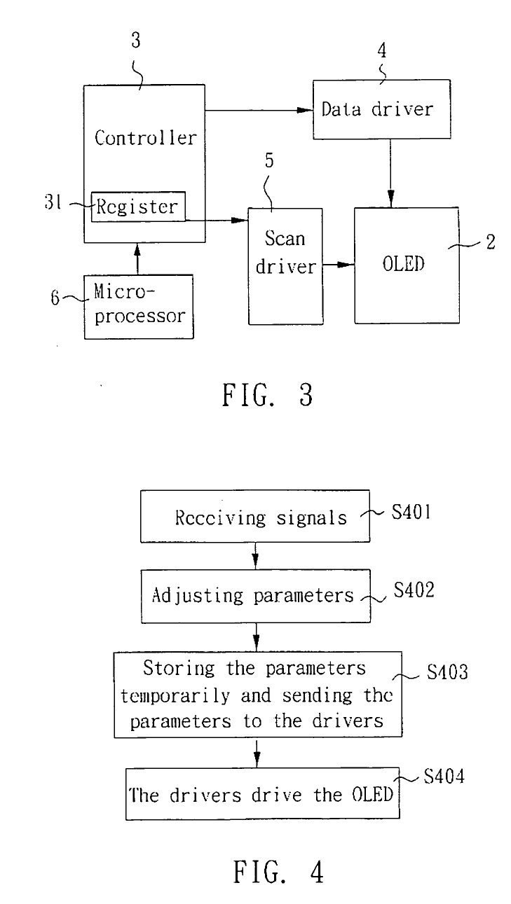

With reference to FIG. 3, there is shown a block diagram of the organic electroluminescent panel and circuit having reduced power consumption of the present invention. The organic electroluminescent display device having reduced power consumption of the present invention comprises an organic electroluminescent panel 2, a controller 3, a data (column) driver 4, and a scan (row) driver 5, among which the controller 3 also connects to a micro-processor 6. The circuit of organic electroluminescent panel for reducing power consumption comprises a controller for receiving an electrical signal for power-saving instruction, adjusting and sending out at least one parameter of the scanning scope or area of the power-saving display frame, the refreshing frequency of the power-saving display frame, the displaying clock of the power-saving display frame, or the displaying luminance of the standby screen of the power-saving display frame, and a memory for storing the parameter of scanning scope or area of the power-saving display frame, the refreshing frequency of the power-saving display frame, the displaying clock of the power-saving display frame, or the displaying luminance of the standby screen of the power-saving display frame adjusted in the controller.

With reference to FIG. 4, there is shown a flow chart of the method for reducing the power consumption of an organic electroluminescent panel of the present invention. In the present embodiment, the micro-processor 6 is preferably to be a central processing unit (CPU). When the CPU transmits an electrical signal for power-saving instruction to the controller 3, then the controller 3 immediately enters the power-saving mode and proceeds a partial scanning (in step S401) on the OLED panel. The partial scanning in the power-saving mode is started after the controller 3 receives an electrical signal for power-saving instruction. The controller 3 evaluates and determines the scanning scope (new scanning area for partial scanning) of scanning area of the display frame at once. Afterwards, the adjusted scanning scope of scanning area of the display frame is stored at a register 31 (in steps S402 and S403). The scanning scope determined by the controller is smaller than the active area of the OLED panel for saving electrical power. In other words, only small scanning scope is scanned within a frame period instead of the scanning of the whole active area of an OLED panel for the power-saving purposes.

In the present embodiment, the area outside the scanning scope or the scanning area of the display frame, i.e. the display area sandwiched between the border of the organic electroluminescent panel and the border of the display frame subsequently gets into a standby mode (i.e. a partial scanning mode). In the standby mode, the display luminance of these areas outside the scanning scope is adjusted to be nearly 0. The controller 3 also adjusts (for reducing the values of the parameter) the parameters of the power-saving display frame, such as the refreshing frequency, and the displaying clock synchronously (in step S402) after the scanning scope or area of power-saving display frame is determined. The adjusted parameters are stored temporarily in a register 31.

Afterwards, the adjusted parameters are transmitted to the data (column) driver 4 and the scan (row) driver 5 respectively (in step S403), and then the organic electroluminescent panel 2 starts to be scanned (in step S404). As a result, the organic electroluminescent panel 2 can get into the power-saving mode and the scanning scope or scanning area of the display frame is defined. The background of the displaying or the unimportantly changed display information can be selectively defined for not scanning at the same time. For example, only the area between the top row and the bottom row of the power-saving display frame is scanned, and the areas above the top row of the power-saving display frame and below the bottom row of the power-saving display frame are not scanned.

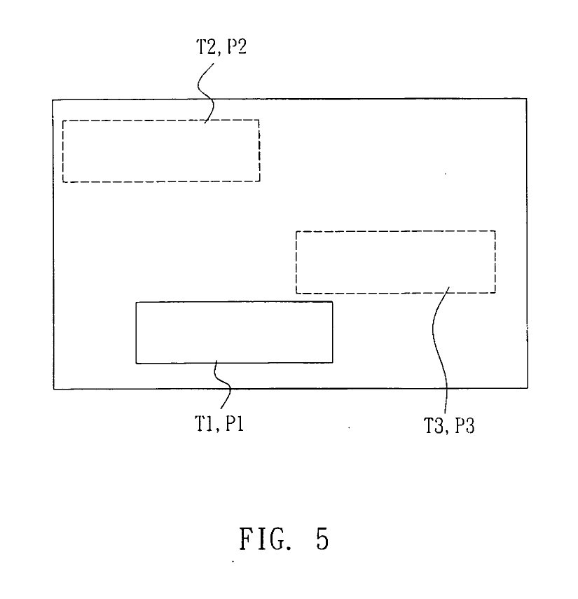

Further, the period for displaying the pixel array or various display frames can be set to display the pixel of the organic electroluminescent panel averagely (as shown in FIG. 5) so that the overusing of the same pixels that may lead to the ineffectiveness of those pixels is prevented. Through the achievement of the method illustrated above, the displaying quality of an OLED is improved, and the lifetime of the OLED panel is therefore extended.

Because part of the display panel operates with a reduced refreshing frequency, reduced display clock, and low display luminance, the power consumed by the displaying of the organic electroluminescent panel is vastly reduced, and thereby the lifetime of the battery used is extended. Moreover, the reduced refreshing frequency and reduced display clock can reduce the starting frequency of the organic electroluminescent panel, and thereby extend the actual lifetime of the display pixels, i.e. the lifetime of the organic electroluminescent panel.

Although the present invention has been explained in relation to its preferred embodiment, it is to be understood that many other possible modifications and variations can be made without departing from the spirit and scope of the invention as hereinafter claimed.

What is claimed is:

1. A method for reducing the power consumption of an organic electroluminescent panel, comprising the following steps:
(A) providing an organic electroluminescent panel, a controller and drivers for driving the organic electroluminescent panel; wherein the controller connects, controls the drivers to drive the organic electroluminescent panel, receives an electrical signal for power-saving instruction by the controller, and adjusts the scanning scope or the scanning area of a power-saving display frame on the organic electroluminescent panel;
(B) reducing the refreshing frequency of the power-saving display frame, the displaying clock of the power-saving display frame, or the displaying luminance of a standby screen of the power-saving display frame of the organic electroluminescent panel by the controller;
(C) storing the scanning scope or area of the power-saving display frame, the refreshing frequency of the power-saving display frame, the displaying clock of the power-saving display frame, or the displaying luminance of the standby screen of the power-saving display frame in a memory, and transmitting the stored scanning scope of the power-saving display frame, the stored refreshing frequency of the power-saving display frame, the stored displaying clock of the power-saving display frame, or the stored displaying luminance of the standby screen of the power-saving display frame to the drivers of the organic electroluminescent panel; and
(D) driving the organic electroluminescent panel to display the power-saving display frame or the standby screen of the power-saving display frame by the drivers.

2. The method as claimed in claim 1, wherein the scanning scope or the scanning area of the power-saving display frame is adjusted to be equal to or greater than the area or the scope of the display block having the highest pixel-on frequency or display frequency in step (A).

3. The method as claimed in claim 1, wherein the reducing of the displaying luminance is achieved by reducing the driving current for driving pixels of the organic electroluminescent panel.

4. The method as claimed in claim 1, wherein the reducing of the refreshing frequency, the displaying clock, or the displaying luminance of the standby screen of the display frame of the organic electroluminescent panel is achieved by a controller.

5. The method as claimed in claim 1 further comprising setting the period for displaying the pixel array or various display frames in step (B) in order to averagely display the pixels of the organic electroluminescent panel.

6. The method as claimed in claim 1, wherein the scanning scope of the power-saving display frame, the refreshing frequency of the power-saving display frame, the displaying clock of the power-saving display frame, or the displaying luminance of the standby screen of the power-saving display frame is stored at a register.

7. An organic electroluminescent panel having reduced power consumption, comprising:
a controller for receiving an electrical signal for power-saving instruction, adjusting and sending out at least one parameter;
a memory for storing the parameter adjusted in the controller;
at least one driver for receiving the parameter from the controller and sending out a control signal; and
an organic electroluminescent panel for receiving the control signal from the driver for displaying.

8. The organic electroluminescent panel as claimed in claim 7, wherein the parameter comprises the scanning scope of the power-saving display frame, the refreshing frequency of the power-saving display frame, the displaying clock of the power-saving display frame, the displaying luminance of the standby screen of the power-saving display frame, or the selective pixel-on frequency.

9. The organic electroluminescent panel as claimed in claim 8, wherein the scanning scope or the scanning area of the power-saving display frame is adjusted to be equal to or greater than the area or the scope of the display block having the highest pixel-on frequency or display frequency.

10. The organic electroluminescent panel as claimed in claim 7, wherein the displaying luminance of the organic electroluminescent panel is reduced through reducing the driving current thereof.

11. The organic electroluminescent panel as claimed in claim 7, further comprising a register for storing the parameter.

12. The organic electroluminescent panel as claimed in claim 7, wherein the driver is a data driver that receives data signals to drive the organic electroluminescent panel.

13. The organic electroluminescent panel as claimed in claim 7, wherein the driver is a scan driver that receives scanning signals to drive the organic electroluminescent panel.

14. A circuit of organic electroluminescent panel for reducing power consumption, comprising:
a controller for receiving an electrical signal for power-saving instruction, adjusting and sending out at least one parameter; and
a memory for storing the parameter adjusted in the controller.

15. The circuit as claimed in claim 14, wherein the parameter comprises the scanning scope of the power-saving display frame, the refreshing frequency of the power-saving display frame, the displaying clock of the power-saving display frame, the displaying luminance of the standby screen of the power-saving display frame, or the selective pixel-on frequency.

16. The circuit as claimed in claim 15, wherein the scanning scope or the scanning area of the power-saving display frame is adjusted to be equal to or greater than the area or the scope of the display block having the highest pixel-on frequency or display frequency.

17. The circuit as claimed in claim 14, further comprising a register for storing the parameter.
